(19) United States
(12) Patent Application Publication
(10) Pub. No.: US 2026/0310050 A1
(43) Pub. Date: Oct. 8, 2026

(54) MOBILE VEHICLE PHOTOBOOTH

(71) Applicant: Carvana IPHC, LLC, Tempe, AZ (US)

(72) Inventors: Charles Veneklase, Tempe, AZ (US); Bruce Moehl, Tempe, AZ (US)

(73) Assignee: Carvana IPHC, LLC, Tempe, AZ (US)

(21) Appl. No.: 19/169,555

(22) Filed: Apr. 3, 2025

(51) Int. Cl. G03B 15/07; F21K 5/06; G03B 17/56

(52) U.S. Cl. CPC G03B 15/07; G03B 15/0442; G03B 17/561; G03B 2217/007

(57) ABSTRACT

A mobile photobooth for use with vehicles is disclosed. The photobooth can comprise one or more trusses, one or more curtains, one or more lifting assemblies, and one or more lights. The one or more trusses can comprise a zip track. The one or more curtains can be slidably coupled to the zip track. The one or more lifting assemblies or the one or more lights can be coupled to the one or more trusses.

### TECHNICAL FIELD

This disclosure generally relates to photobooths, and more specifically, to photobooths used for vehicle photography.

### BACKGROUND

Producing high quality images of vehicles can be time consuming and costly. One method is to hire a professional photographer to photograph an entirety of a vehicle, but the photographer may have limited throughput. Moreover, the photo session may be subject to environmental conditions (e.g., weather restrictions, night/day cycles, lighting challenges, etc.). Further, human variation can introduce inconsistencies in framing between shots and vehicles.

Furthermore, traditional, fixed vehicle photobooths can be effective at increasing consistency and throughput, but are expensive to construct, move, and operate. Therefore, there is a strong need for a more cost effective, a more consistent, and/or higher throughput vehicle photobooth.

### SUMMARY

Many embodiment can comprise a mobile photobooth for use with vehicles. The photobooth can comprise one or more trusses, one or more curtains, one or more lifting assemblies, and one or more lights. The one or more trusses can comprise a zip track. The one or more curtains can be slidably coupled to the zip track. The one or more lifting assemblies or the one or more lights can be coupled to the one or more trusses.

Various embodiments can comprise a method of constructing a vehicle photobooth. The method can comprise slidably coupling one or more curtains to a zip track; coupling one or more lifting assemblies to the one or more trusses; and coupling one or more lights to the one or more trusses. The one or more trusses can comprise a zip track.

Further embodiments can comprise a method of using a vehicle photobooth. The method can comprise moving a vehicle into the vehicle photobooth and capturing photographs of the vehicle using a camera. The photobooth can comprise one or more trusses, one or more curtains, one or more lifting assemblies, and one or more lights. The one or more trusses can comprise a zip track. The one or more curtains can be slidably coupled to the zip track. The one or more lifting assemblies or the one or more lights can be coupled to the one or more trusses.

### BRIEF DESCRIPTION OF THE DRAWINGS

To facilitate further description of the embodiments, the following drawings are provided in which:

FIG. 1 illustrates a cutaway view of a mobile vehicle photobooth, in accordance with various embodiments.

FIG. 2 illustrates an isolated view of a truss, in accordance with various embodiments.

FIG. 3 illustrates an enlarged view of a mobile vehicle photobooth showing a lifting assembly for a truss system, in accordance with various embodiments.

FIG. 4 illustrates an enlarged view of a mobile vehicle photobooth showing mounting assemblies for a light and a winch, in accordance with various embodiments.

FIG. 5 illustrates an enlarged view of a mobile vehicle photobooth showing a mounting assembly for a lifting assembly, in accordance with various embodiments.

FIG. 6 illustrates a side view of a mobile vehicle photobooth suspended from vertical members, in accordance with various embodiments.

FIG. 7 illustrates an enlarged view of a mobile vehicle photobooth showing a tube truss lifting assembly, in accordance with various embodiments.

FIG. 8 illustrates an enlarged view of a mobile vehicle photobooth showing a bumper, in accordance with various embodiments.

FIG. 9 illustrates an enlarged view of a mobile vehicle photobooth showing a bumper with an insert, in accordance with various embodiments.

FIG. 10 illustrates an enlarged, cross-sectional view of a truss, in accordance with various embodiments.

FIG. 11 illustrates an isometric view of a beam clamp, in accordance with various embodiments.

### DETAILED DESCRIPTION

This disclosure describes a mobile photobooth for photographing vehicles (e.g., cars, trucks, vans, busses, motorcycles, watercraft, etc.). The mobile photobooth can be assembled and/or disassembled. When disassembled, the mobile photobooth can be moved to a new location. When assembled, the mobile photobooth can provide for increased consistency in lighting and/or framing of vehicle photographs.

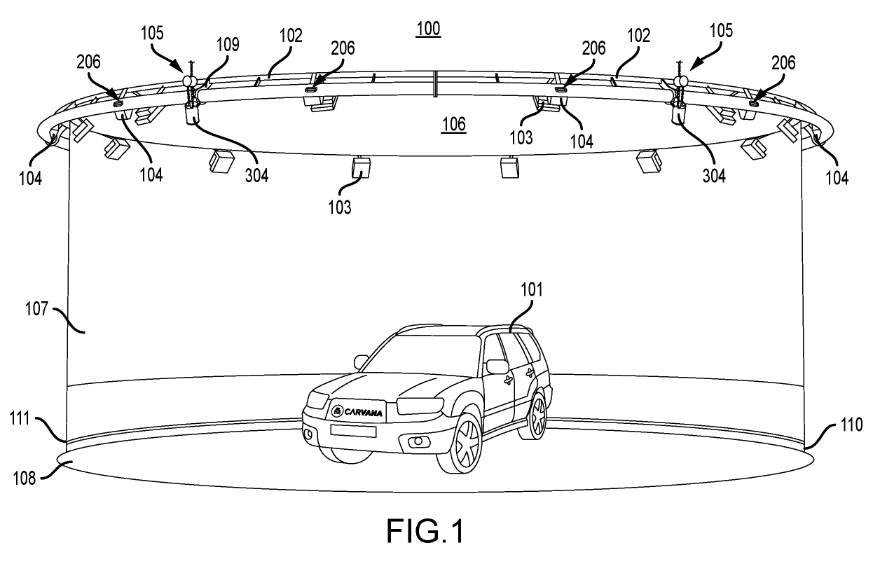

FIG. 1 illustrates an exemplary embodiment of a mobile photobooth 100 in a cutaway view. Photobooth 100 is merely exemplary and is not limited to the embodiments presented herein. Photobooth 100 can be employed in many different embodiments or examples not specifically depicted or described in this disclosure. In some embodiments, the elements of photobooth 100 can be coupled in the arrangement presented. In various embodiments, the elements of photobooth 100 can be coupled in any suitable arrangement. In still further embodiments, one or more of the elements of photobooth 100 can be combined or omitted.

Photobooth 100 can be used to increase the consistency of lit photographs of a vehicle 101. Photobooth 100 can comprise truss 102, light 103, curtain winch 104, truss winch 105, top cap 106, curtain 107, and/or floor 108. A plurality of trusses 102 can be coupled together at truss interface 109 to create an upper frame for photobooth 100. Each truss 102 can be arced and/or curved such that, when coupled together in a closed shape, the trusses form a circle. Truss 102 can be made from a number of different rigid and/or hard materials. For example, truss 102 can be made from a lightweight metal or metal alloy (e.g., aluminum, titanium, etc.). Light 103 can comprise a high flux light. For example, light 103 can comprise a light described in U.S. Patent No. 12,003,840 entitled “Light emitting diode fixtures for vehicle photographic systems,” which is incorporated by this reference in its entirety. In various embodiments, light 103 can be adjustable and/or tunable by a computer system. For example, a computer system can adjust and/or tune light 103 depending on whether an interior or exterior of a vehicle is being photographed and/or whether vehicle imperfections (e.g., dings, dents, scratches) or specific features (e.g., spoilers, sunroofs, aftermarket parts) are being highlighted. A plurality of lights 103 can be electrically coupled together, thereby sharing a power source and/or data connection to a computer system. In these embodiments, the plurality of lights 103 can be daisy chained via one or more power cords. Curtain winch 104 can be mechanically coupled to a bottom of curtain 107. When activated, curtain winch 104 can pull a bottom portion (e.g., a bottom edge) of curtain 107 up towards truss 102. In this way, curtain 107 can be lifted so that vehicle 101 can enter and/or exit photobooth 100. Truss winch 105 can couple one or more trusses 102 to an overhead structure (e.g., a ceiling, a truss, a crane, etc.), thereby suspending photobooth 100 from the overhead structure.

Curtain 107 can comprise two portions: an upper lighter portion and a lower darker portion. For example, the upper portion can be white, while the lower portion can be grey. In various embodiments, floor 108 can be the same or a similar color to a lower portion of curtain 107. Curtain 107 can have an opaque back that blocks interior light (e.g., from lights 103) from entering photobooth 100 and/or exterior lights from entering photobooth 100. In various embodiments, a bottom portion of curtain 107 can have one or more weights to aid in keeping curtain 107 taught when suspended from truss 102. For example, there can be a pocket 110 proximate to a bottom edge of curtain 107 filled with weights (e.g., a chain). A second pocket 111 can also be located on a bottom portion of curtain 107. Pocket 111 can be configured to house one or more rigid members. The rigid members in pocket 111 can aid in shaping curtain 107 (e.g., so that a shape of curtain 107 approximates a shape created by trusses 102) and/or provide an attachment point for a winch (e.g., curtain winch 104). In various embodiments, curtain 107 can comprise one or more grommets on an exterior surface of curtain 107. The grommets can allow a chain, rope, or cable mechanically linked with curtain winch 104 to couple curtain 107, thereby allowing curtain 107 to be lifted by curtain winch 104. In various embodiments, curtain 107 can have a zipper running along its side edges from top to bottom. In these embodiments, one or more curtains can be coupled together to form a closed shape similar to the closed shape created by a plurality of trusses 102. The zipper can be hidden from view by a fabric flap when photobooth 100 is in use. In various embodiments, a side edge zipper can be colored such that it blends in with curtain 107 (e.g., with a lighter upper portion and/or a darker lower portion). Top cap 106 can be a similar color to a top portion of curtain 107 and be constructed of similar materials. For example, top cap 106 can have an opaque back that blocks interior light (e.g., from lights 103) from exiting photobooth 100 and/or exterior lights from entering photobooth 100. In some embodiments, top cap 106 can be made from a fire retardant and/or a melt away fabric. A melt away fabric can comprise one or more meltable threads and/or strips embedded and/or woven into top cap 106. When the melt away fabric reaches a predetermined temperature (e.g., 160° Fahrenheit), it can melt, thereby separating one or more panels that make up top cap 106. Melting of melt away fabric can allow for gaps to open in top cap 106, thereby allowing one or more fire suppression systems (e.g., sprinklers) to be applied to an interior of photobooth 100. Floor 108 can be a similar color to a bottom portion of curtain 107. In various embodiments, the bottom portion of curtain 107 can blend in with floor 108 in photographs taken within photobooth 100.

In various embodiments, photobooth 100 can comprise one or more image capture systems. A number of different image capture systems can be used with photobooth 100. For example, a handheld camera, a smartphone, a wearable electronic device, and/or some other portable electronic device that includes an image sensor and/or camera can be used. In some embodiments, a human holding an electronic device can walk, run, and/or be transported around a vehicle while capturing images and/or video. In some embodiments, an autonomous vehicle (AV) mounted camera can be used to capture images of a vehicle. An AV can be moved in an approximately circular or elliptical path around a vehicle. The AV can move a camera so that the camera focuses on the vehicle while the AV travels along the path around the vehicle. In various embodiments, an AV can repeat a path around a vehicle at multiple altitudes, heights, and/or depths to capture additional images. In various embodiments, an AV can include multiple cameras at different altitudes, heights, and/or depths to capture the additional images. As another example, one or more cameras can be mounted to an approximately circular rail along a circumference of an interior chamber of photobooth 100, and these cameras can then be moved around the object while taking photographs. As another example, floor 108 can be configured to rotate while one or more cameras mounted at fixed positions take photographs. One or more cameras in photobooth 100 can be set at multiple levels to capture varied angles of a vehicle at different altitudes, heights, and/or depths. For example, a first camera can be placed on a floor, a second camera can be placed above a vehicle (e.g., directly above and/or angled down at the vehicle), and a third can be placed between the first and the second cameras. In some embodiments, an image capturing system can be electrically coupled with one or more computer systems. The computer systems can construct 3D models of vehicles using images captured within photobooth 100.

In various embodiments, photobooth 100 can comprise a vehicle centering system. The vehicle centering system can be configured to alert a driver of vehicle 101 when it is in an approximate center of photobooth 100. Vehicle centering system can comprise one or more cameras and/or one or more LED lights. For example, a 180°, fisheye, and/or wide angle camera can be mounted on one or more of truss 102, light 103, curtain winch 104, truss winch 105, and/or top cap 106. In some embodiments, the cameras can be a computer system (e.g., via a data cable, wireless connections, and/or a network). The cameras and/or the computer system can visually track vehicle 101 as it enters photobooth 100 using one or more computer vision algorithms. An area of floor 108 can be designated as an approximate center of photobooth 100. When vehicle 101 enters the approximate center of photobooth 100, an alert can be sent to a driver of vehicle 101. For example, one or more LED lights visible to the driver can be activated to instruct the driver to stop vehicle 1010. In various embodiments, a vehicle centering system can comprise one or more convex mirrors. Convex mirrors can be placed outside of photobooth 100 to indicate when a driver of vehicle 101 has placed vehicle 101 in an approximate center of photobooth 100.

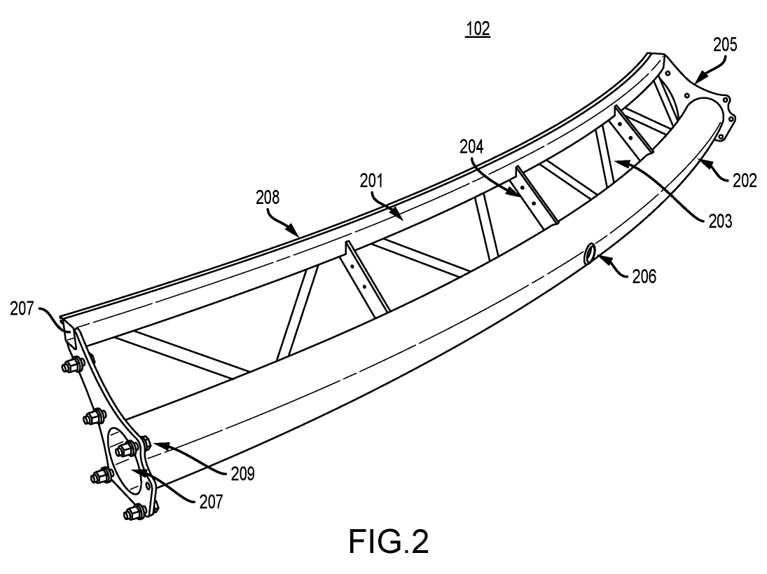

FIG. 2 shows truss 102 in an isolated view. Truss 102 can comprise square tube 201, large O-tube 202, small O-tube 203, bracket plate 204, end plate 205, cable passthrough 206, end opening 207, zip track 208, and/or fasteners 209. While square tube 201 and O-tubes 202-203 are shown with specific cross sectional shapes in FIG. 2, it should be understood that one or more of square tube 201 and O-tubes 202-203 could have other cross sectional shapes and/or be solid. For example, square tube 201 could have a circular cross section, a triangular cross section, a rectangular cross section, etc. As another example, square tube 201 could be solid with no or minimal interior voids. Further, one or more of O-tubes 202-203 could have a square cross section, a triangular cross section, a rectangular cross section, or be solid with no or minimal interior voids.

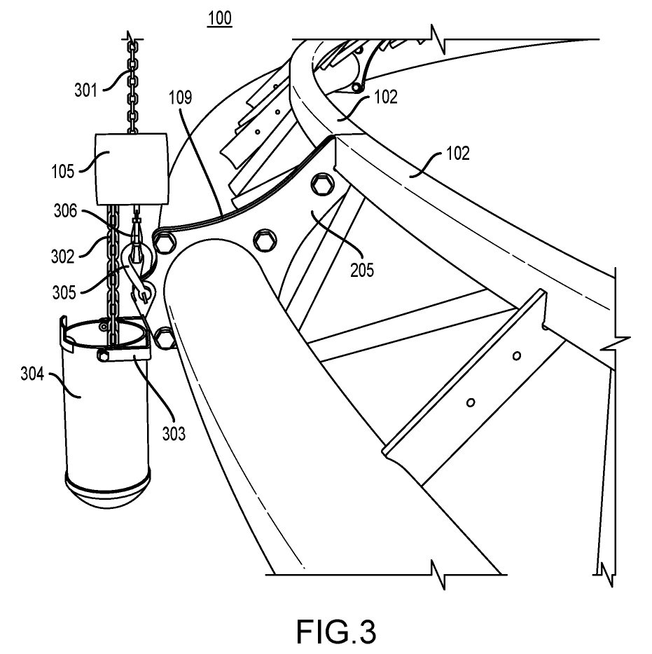

Small O-tube 203, bracket plate 204, and/or end plate 205 can extend between and/or be coupled to square tube 201 and large O-tube 202, thereby coupling square tube 201 and O-tube 202 together to form a truss structure. In these embodiments, square tube 201 can comprise a top chord of the truss, large O-tube 202 can comprise a bottom chord of the truss, and small O-tube 203, bracket plate 204, and/or end plate 205 can comprise one or more web members of the truss. In this way, one or more of square tube 201, O-tubes 202-203, bracket plate 204, and/or end plate 205 can support a weight of elements coupled to photobooth 100 (FIG. 1) when in an assembled configuration. End plate 205 can comprise one or more fastener coupling points for coupling fasteners 209 and/or truss coupling pin 305 (FIG. 3). While fasteners 209 are shown in FIG. 2 as nuts and bolts, it should be understood that additional fasteners could be used. For example, fasteners 209 can comprise one or more rivets and/or one or more welds. In some embodiments, fasteners 209 can be Zinc coated, thereby increasing their strength and/or durability over traditional fasteners. A plurality of trusses 102 can be coupled together by coupling their respective end plates 205 together on their interior faces. Cable passthrough 206 can comprise an opening in one or more of square tube 201 and large O-tube 202 that allows power and/or computing cables to be routed through truss 102. In some embodiments, cable passthrough 206 can have a rubber coating or grommet on its circumference. In this way, damage to an exterior of the power and/or computing cables can be minimized or eliminated. While cable passthrough 206 is shown in FIG. 2 as being located on a lateral portion of large O-tube 202, it should be understood that cable passthrough 206 can be located on other portions of large O-tube 202 and/or square tube 201. For example, cable passthrough 206 can be located on a top portion, a bottom portion, and/or somewhere in between the top, bottom, and/or lateral portions of one or more of large O-tube 202 and/or square tube 201. Further, more than one cable passthrough 206 can be located on of large O-tube 202 and/or square tube 201. Much like cable passthrough 206, end openings 207 allows power and/or computing cables to be routed through truss 102.

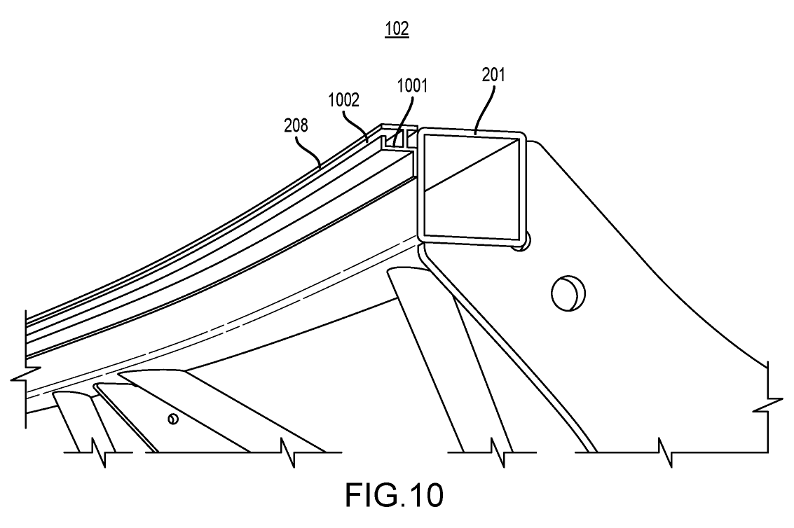

FIG. 10 illustrates an enlarged, cross-sectional view of truss 102 is shown. In various embodiments, truss 102 can comprise a track 208 for suspending and/or coupling curtain 107 (FIG. 1) to truss 102. Track 208 can be coupled to square tube 201 or another most interior portion of truss 102. In this way, when curtain 107 (FIG. 1) is coupled to truss 102, additional elements of photobooth 100 (FIG. 1) that are not suitable for being in a photograph of a vehicle (e.g., structural elements of truss 102, curtain winch 104 (FIG. 1), truss winch 105 (FIG. 1), and/or curtain winch 105 (FIG. 1)) can be hidden from view in the photograph. Track 208 can be made from extruded metal (e.g., aluminum), plastic, or some other durable and/or rigid material. In many embodiments, track 208 can be arced and/or curved in a similar and/or approximate fashion to truss 102. Track 208 can comprise an approximately uniform channel 1001 along its length to accommodate rollers, wheels, or sliders coupled to curtain 107 (FIG. 1). In many embodiments, the channel 1001 can have a cross sectional shape that is complementary to the rollers, wheels, or sliders coupled to curtain 107 (FIG. 1). The channel 1001 can have an outlet 1002 extending towards one or more of floor 108 (FIG. 1) or an approximate center of photobooth 100 (FIG. 1). The rollers, wheels, or sliders coupled to curtain 107 (FIG. 1) can be fed into the channel 1001 with curtain 107 (FIG. 1) extending out of track 208 through the outlet 1002. In this way, curtain 107 (FIG. 1) can be slidably and/or removable coupled to truss 102. In some embodiments, track 208 can comprise a first half of a zipper coupled to truss 102. In these embodiments, curtain 107 (FIG. 1) can comprise a half of a zipper coupled with a corresponding half of a zipper on curtain 107 (FIG. 1). In these embodiments, the two halves of the zipper can be zipped together to couple curtain 107 (FIG. 1) to truss 102.

FIG. 3 illustrates an enlarged view of photobooth 100 showing additional details of mounting assemblies for truss winch 105 and/or truss interface 109. In various embodiments, the mounting assembly can comprise ceiling chain 301, curtain winch 105, hoist chain 302, chain container bracket 303, chain container 304, and/or truss coupling pin 305. Ceiling chain 301 can be of a fixed length and couple photobooth 100 to an overhead structure (e.g., a ceiling, a truss, a crane, etc.), thereby suspending photobooth 100 from the overhead structure. While ceiling chain 301 is shown as a chain, it should be understood that it can be replaced with a rope, cable, or some similar tethering material. Truss winch 105 can comprise a mechanical lifting device used to raise and/or lower one or more trusses 102. Truss winch 105 can be operated by pulling chain 302, thereby turning a set of gears within truss winch 105 to lift or lower one or more trusses 102. As chain 302 is pulled, the resulting excess chain can be stored in chain container 304 to prevent chain 302 from being a hazard to vehicles and/or humans. While truss winch 105 is described with reference to chains, it should be understood that a construction of truss winch 105 can vary depending on a tethering material used. For example, if a rope or cable is used, truss winch 105 can be replaced with a pulley system. Chain container bracket 303 can be coupled to chain container 304, thereby securing chain container 304 to chain container bracket 303. Chain container bracket 303 can also be coupled to one or more trusses 102 at truss interface 109. In some embodiments, chain container bracket 303 can be coupled to one or more trusses 102 on an exterior surface of each respective end plate 205. Truss coupling pin 305 can be used to couple together a plurality of trusses 102 or can be coupled to only one truss 102 using one or more fasteners. Truss coupling pin 305 can be coupled to an exterior surface of each respective end plate 205 of the plurality of trusses 102. In many embodiments, truss coupling pin 305 can be coupled to an exterior surface of chain container bracket 303 and/or couple chain container bracket 303 to one or more trusses 102. In some embodiments, truss coupling pin 305 can extend above and/or over truss interface 109, thereby creating a loop, an eye, or some other coupling mechanism for winch hook 306. Winch hook 306 can extend away from truss winch 105 and couple to truss coupling pin 305. Winch hook 306 can comprise one or more movable portions similar to those one a carabiner clip, thereby allowing truss coupling pin 305 to couple to winch hook 306 while preventing accidental uncoupling. In this way, truss winch 105 can be coupled to (and therefore be able to move) one or more trusses 102.

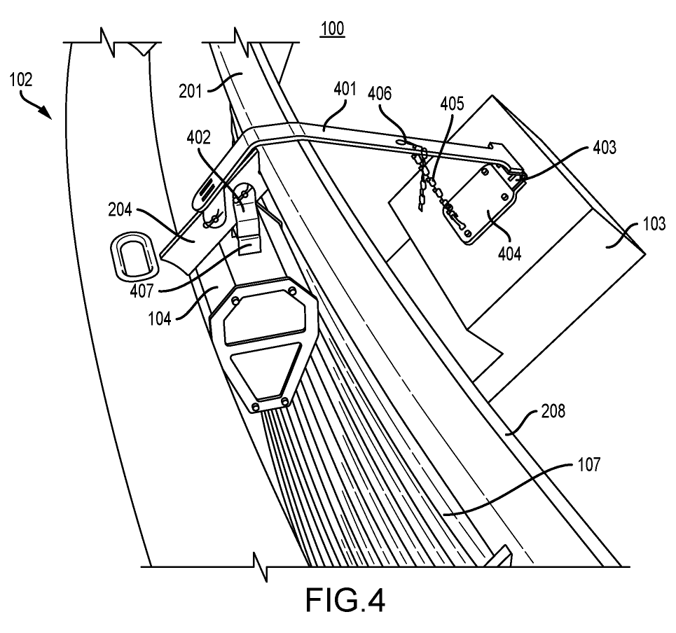

FIG. 4 illustrates an enlarged view of photobooth 100 showing additional details of mounting assemblies for light 103 and curtain winch 104. In various embodiments, the mounting assemblies can comprise truss bracket 401 and/or winch bracket 402. One or more of truss bracket 401 and/or winch bracket 402 can be coupled to bracket plate 204 using one or more fasteners (e.g., nut and bolt, rivets, welds, etc.). In various embodiments, one or more of truss bracket 401 and/or winch bracket 402 can be coupled to bracket plate 204 using one or more quick release fasteners, thereby allowing light 103 and/or curtain winch 104 to be quickly and easily removed from truss 102 for maintenance and/or replacement. For example, one or more of truss bracket 401 and/or winch bracket 402 can be coupled to bracket plate 204 using one or more clevis/cotter pin assemblies. Winch bracket 402 can be shaped such that it couples bracket plate 204 at a top portion and couples curtain winch 104 at a bottom portion. In various embodiments, a top portion of winch bracket 402 can be narrower than a bottom portion of winch bracket 402. Winch bracket 402 can be coupled to a coupling portion 407 of curtain winch 104 via one or more fasteners (e.g., nut and bolt, rivets, welds, etc.) and/or one or more quick release fasteners (e.g., a clevis/cotter pin assembly).

Truss bracket 401 can be shaped such that it extends from bracket plate 204 into an interior chamber of photobooth 100. For example, truss bracket 401 can extend through a gap between top cap 106 (FIG. 1) and square tube 201 and/or zip track 208. In this way, light 103 can be placed within a photographic chamber of photobooth 100 without exposing additional elements of photobooth 100 that are not suitable for being in a photograph of a vehicle. Truss bracket 401 can be coupled to hinge 403. Hinge 403 can comprise one or more interlocking metal plates. One metal plate can be coupled to truss bracket 401 while a second can be coupled to back plate 404. The metal plates can be joined at a pivot point, thereby allowing rotational movement of the plates while light 103 is maintained in a stable and secured position. Back plate 404 can be coupled to a back surface of light 103 and can comprise one or more connection points for coupling to chain 405. Chain 405 can in turn be threaded through one or more cutouts 406 on truss bracket 401. As a length of chain 405 extending from truss bracket 401 to back plate 404 is shortened or lengthened, a hinge angle of having 403 can be adjusted to be smaller or larger, respectively. In this way, an angle of light 103 within photobooth 100 can be adjusted, thereby changing the lighting in photographs taken within photobooth 100. While chain 405 is shown threaded through cutout 406, it should be understood that a number of different elements can be used to the same effect. For example, chain 405 can be replaced with a rope, cable, or some similar tethering material. Further, a tethering material can be coupled to truss bracket 401 via a number of different structures. For example, a tethering material can be wrapped around a hook, tied around truss bracket 401 without using a cutout, or coupled to truss bracket 401 using one or more fasteners (e.g., a quick release fastener).

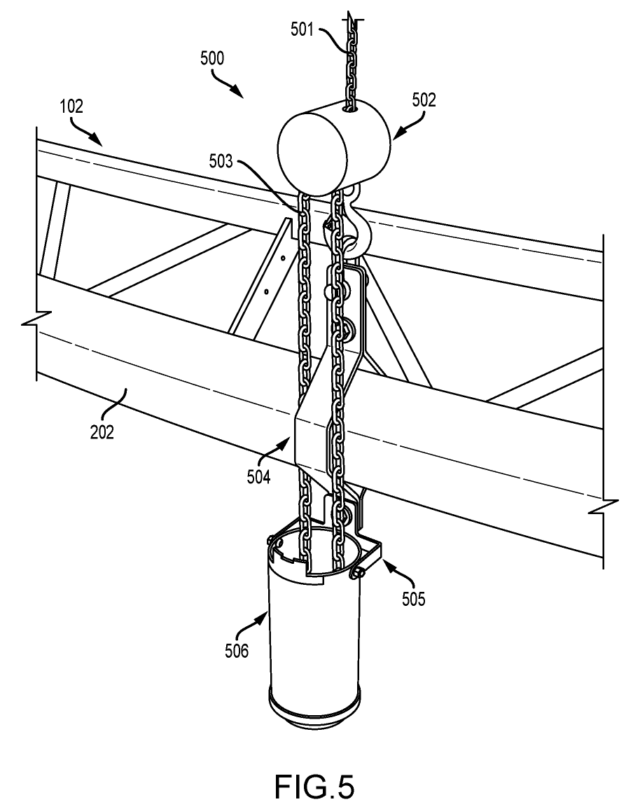

FIG. 5 illustrates an enlarged view of lifting assembly 500. In many embodiments, lifting assembly can be used as an alternative to and/or in addition to the assembly associated with truss winch 105 (FIG. 1). In various embodiments, the mounting assembly can comprise ceiling chain 501, chain hoist 502, hoist chain 503, truss clamp 504, chain container bracket 505, and/or chain container 506. Ceiling chain 501 can be of a fixed length and couple photobooth 100 to an overhead structure (e.g., a ceiling, a truss, a crane, etc.), thereby suspending photobooth 100 from the overhead structure. While ceiling chain 501 is shown as a chain, it should be understood that it can be replaced with a rope, cable, or some similar tethering material. Chain hoist 502 can comprise a mechanical lifting device used to raise and/or lower one or more trusses 102. Chain hoist 502 can be operated by pulling chain 503, thereby turning a set of gears within chain hoist 502 to lift or lower one or more trusses 102. As chain 503 is pulled, the resulting excess chain can be stored in chain container 506 to prevent chain 503 from being a hazard to vehicles and/or humans. While chain hoist 502 is described with reference to chains, it should be understood that a construction of chain hoist 502 can vary depending on a tethering material used. For example, if a rope or cable is used, chain hoist 502 can be replaced with a pulley system. Chain hoist 502 can be coupled to large O-tube 202 using truss clamp 504. Truss clamp 504 can comprise two complementary portions secured together via one or more fasteners (e.g., a quick release fastener). The two complementary portions of truss clamp 504 can, when joined, have a narrower upper portion to accommodate coupling via the fasteners, a broader middle portion for circumscribing large O-tube 202, and then a narrower lower portion to accommodate coupling via the fasteners. Chain container bracket 505 can be coupled to truss clamp 504 at a lower narrow portion. In some embodiments, chain container bracket 505 can be coupled truss clamp 504 using the same fastener that couples the two complementary portions of truss clamp 504. Chain container bracket 505 can be coupled to chain container 506, thereby securing chain container 506 to chain bracket 505.

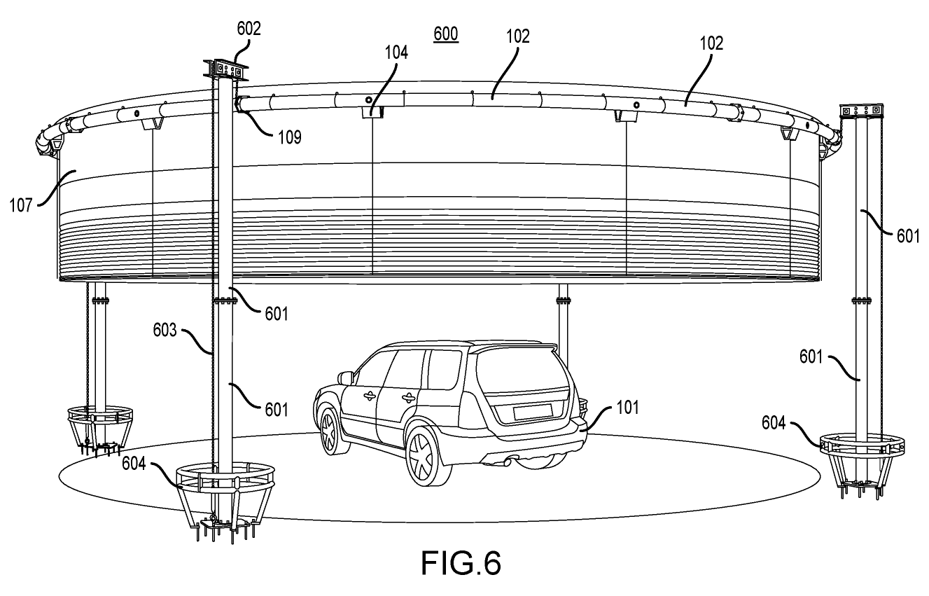

FIG. 6 illustrates an exemplary embodiment of a mobile photobooth 600 in a side view. Photobooth 600 is merely exemplary and is not limited to the embodiments presented herein. Photobooth 600 can be employed in many different embodiments or examples not specifically depicted or described in this disclosure. In some embodiments, the elements of photobooth 600 can be coupled in the arrangement presented. In various embodiments, the elements of photobooth 600 can be coupled in any suitable arrangement. In still further embodiments, one or more of the elements of photobooth 600 can be combined or omitted.

Photobooth 600 can be used to increase the consistency of lit photographs of a vehicle 101. Photobooth 600 can be similar in many respects to and/or use many similar elements of one or more of photobooth 100 (FIG. 1). In various embodiments, photobooth 600 can comprise one or more vertical members 601, one or more tube truss lifting assemblies, chain 603, and/or bumper 604. Vertical member 601 can comprise a hollow tube or a solid member having various cross sections (e.g., circular, triangle, square, rectangle, etc.) capable of supporting a weight of a plurality of trusses 102. Ends of vertical member 601 can comprise and end cap and/or flange for receiving one or more fasteners. In some embodiments, a plurality of vertical members 601 can be coupled together at the ends via one or more fasteners to achieve a sufficient height for curtain 107 to fully unfurl. A bottommost vertical member 601 can be coupled to a floor and/or ground surface (e.g., floor 108 (FIG. 1)) via one or more fasteners. In this way, photobooth 600 can be securely fastened to the floor and/or ground surface.

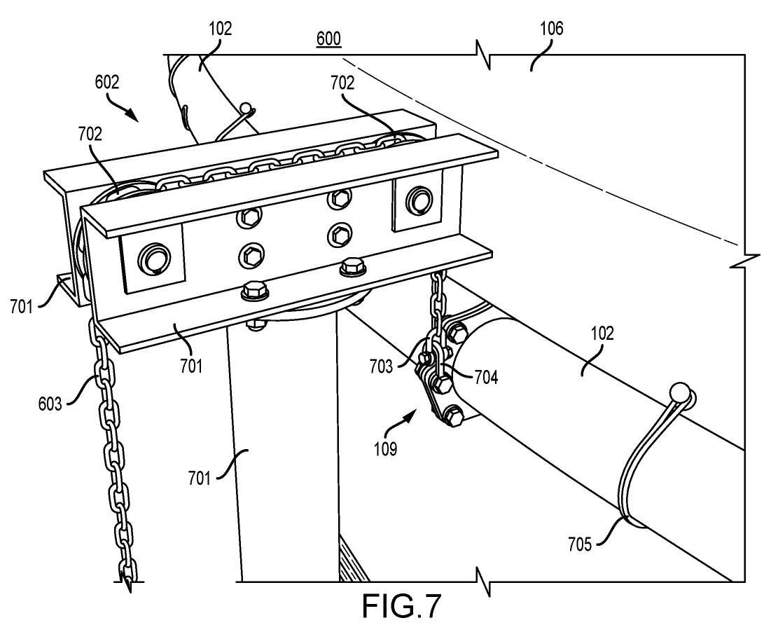

FIG. 7 illustrates an enlarged view of photobooth 600 showing additional details of tube truss lifting assembly 602. Tube truss lifting assembly can comprise C-channels 701, pullies 702, and/or U-bolts 703-704. The pullies 702 can be rotatably coupled to C-channels 701 and can receive chain 603. While chain 603 is shown as a chain, it should be understood that it can be replaced with a rope, cable, or some similar tethering material. Further, while C-channels 701 are shown as C-channels, it should be understood that they can be replaced with brackets, plates, or some similar member for coupling pullies 702. Additionally, while pullies 702 are shown as pullies, it should be understood that they can be replaced with one or more gears sized to receive the links of chain 603. Tube truss lifting assembly 602 can comprise a mechanical lifting device used to raise and/or lower one or more trusses 102. Tube truss lifting assembly 602 can be operated by pulling chain 603, thereby turning one or more of pullies 702 while they are rotatably coupled to one or more of C-channels 701, in this way, the plurality of trusses 102 can be lifted or lowered as desired. Chain 603 can be coupled to truss 102 at truss interface 109. U-bolt 703 can serve as a coupling between chain 603 and U-bolt 704. U-bolt 704 can couple to U-bolt 703 as well as aid in coupling together a plurality of trusses 102. Top cap 106 can be coupled to truss 102 using one or more elastic fasteners 705.

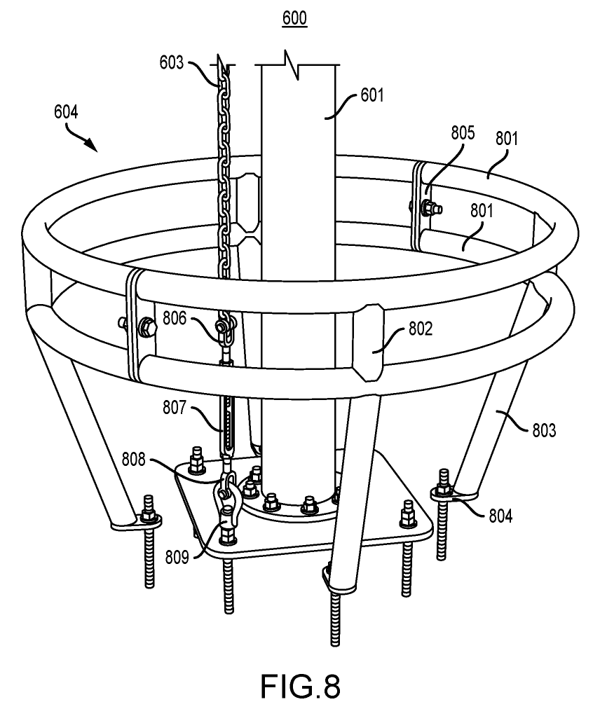

FIG. 8 illustrates an enlarged view of photobooth 600 showing additional details of bumper 604. Bumper 604 can be suitable for protecting vertical member 601 from damage due to collision with a vehicle (e.g., vehicle 101 (FIG. 6)). Due to its design, bumper 604 can act as a crumple zone that is deformed and/or destroyed before a vehicle can make contact with vertical member 601. In some embodiments, bumper 604 can be comprised of two halves that, when coupled together, create a whole bumper 604. Bumper 604 can comprise one or more curved members 801, one or more vertical bumper members 802, one or more diagonal members 803, and/or one or more end brackets 804. Curved member 801, vertical bumper member 802, diagonal member 803, and/or end bracket 804 can be made from a strong and/or rigid metal or metal alloy (e.g., steel, tungsten, etc.). Curved member 801, vertical bumper member 802, and/or diagonal member 803 can each comprise a hollow tube or a solid member having various cross sections (e.g., circular, triangle, square, rectangle, etc.). Curved member 801 can be arced and/or curved such that, when two halves of a bumper are coupled together in a closed shape, the bumper forms a circle around vertical member 601. Vertical bumper member 802 can extend between and/or couple together a plurality of curved members 801. Diagonal member 803 can extend down from one or more of curved member 801 and/or vertical bumper member 802. Diagonal member 803 can extend inward towards a bottom bracket of vertical member 601. In this way, collisions with bumper 604 can be made into one or more of curved member 801 and/or vertical bumper member 802, thereby leading to the aforementioned crumpling functionality. Diagonal member 803 can end with an end backet 804 configured to receive one or more fasteners. The fasteners can couple bumper 604 to a ground, thereby increasing its stability and ability to crumple instead of move.

A termination of chain 603 can also pass through an interior portion of bumper 604. U-bolt 806 can couple chain 603 to a tension adjuster 807. Tension adjuster 807 can be rotatably actuated to shorten or lengthen, depending on direction. In this way, a tension in chain 603 can be modulated. Tension adjuster 807 can be coupled to U-bolt 808, which in turn can couple to eye bolt 809. Eye bolt 809 can be coupled to one or more fasteners used to couple vertical member 601 to a ground. In this way, chain 603 can securely be fixed in place, thereby holding one or more trusses 102 (FIG. 6) at a steady height.

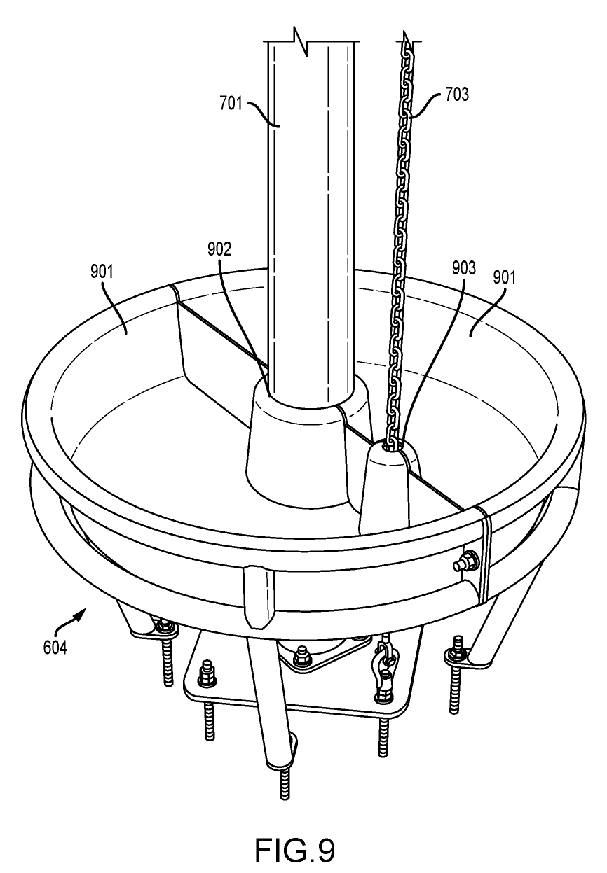

FIG. 9 illustrates bumper 604 comprising an insert. The insert can comprise two halves 901 configured to provide further stability to bumper 604. When coupled together, the two halves 901 can create opening 902 for vertical member 601 and opening 903 for chain 603.

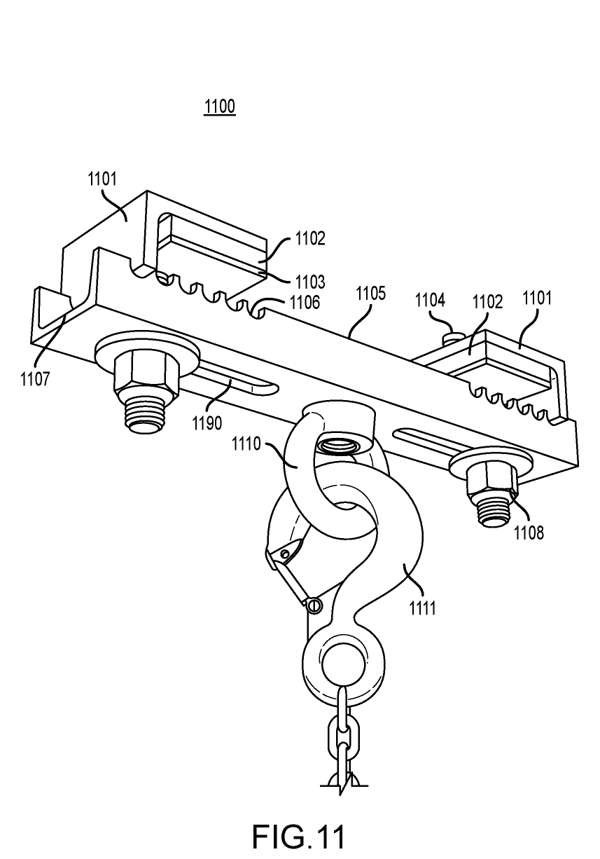

FIG. 11 illustrates an isometric view of beam clamp 1100. Beam clamp 1100 can comprise L-member 1101, clamp pad 1102, clamp cushion 1103, pad fastener 1104, bottom member 1105, notch 1106, trench 1107, fastener 1108 opening 1109, and/or eye 1110. L-member 1101 can be made from a number of different rigid and/or hard materials. For example, L-member 1101 can be made from a lightweight metal or metal alloy (e.g., aluminum, titanium, etc.). L-member 1101 can be shaped such that it can couple to an upper and/or lower flange of an I-beam. For example, a height of L-member 1101 can be sufficient to accommodate a thickness of a flange on an I-beam. A width of L-member 1101 can be sufficient to accommodate half of a flange width (e.g., a distance from a tip of the flange to the web). Clamp pad 1102 can be made from a number of different rigid and/or hard materials. For example, clamp pad 1102 can be made from a lightweight metal or metal alloy (e.g., aluminum, titanium, etc.). Clamp pad 1102 can be coupled to clamp cushion 1103. Clamp cushion 1103 can be made from a flexible and/or compressible material configured to aid beam clamp 1100 in coupling an I-beam. For example, clamp cushion 1103 can be made from rubber and/or plastic. Pad fastener 1104 can removably couple clamp pad 1102 to L-member 1101, thereby allowing clamp pad 1102 to be replaced or repaired when clamp pad 1102 and/or clamp cushion 1103 has been degraded. L-member 1101 can be coupled to bottom member 1105. Much like L-member 1101, bottom member 1105 can be made from a number of different rigid and/or hard materials. For example, bottom member 1105 can be made from a lightweight metal or metal alloy (e.g., aluminum, titanium, etc.). Bottom member 1105 can comprise one or more notches 1106 in its sidewall and a trench 1107 running along its lengthwise axis. A bottom portion of L-member 1101 can have a complementary shape to trench 1107 and fit within trench 1107. The complementary shape can provide for a more stable coupling between L-member 1101 and bottom member 1105. Coupling between L-member 1101 and bottom member 1105 can be achieved using fastener 1108. A male portion of fastener 1108 can extend down from and/or be fixed or coupled to L-member 1101. When L-member 1101 is coupled to bottom member 1105, fastener 1108 can extend through opening 1109 and be secured by a female portion of fastener 1108. Beam clamp 1100 can be coupled to a variety of sizes of I-beams by adjusting a position of fastener 1108 relative to opening 1109. Fastener 1108 can be uncoupled and L-member 1101 can be moved between one or more of notches 1106. Fastener 1108 can then be coupled to bottom member to provide for a more secure hold on an I-beam. Eye 1110 can couple one or more hooks 1111. Hook 1111 can then be coupled to various portion of a photobooth (e.g., photobooth 100 (FIG. 1), truss 102 (FIG. 2), truss winch 105 (FIG. 3), chain hoist 502 (FIG. 5), and/or tube truss lifting assembly 602 (FIG. 6)).

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in various embodiments, the time delay can be less than approximately one second, two seconds, five seconds, or ten seconds.

As defined herein, “approximately” can, in some embodiments, mean within plus or minus ten percent of the stated value. In various embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although a mobile vehicle photobooth has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A vehicle photobooth comprising:
one or more trusses comprising a zip track;
one or more curtains slidably coupled to the zip track;
one or more lifting assemblies coupled to the one or more trusses; and
one or more lights coupled to the one or more trusses.

2. The vehicle photobooth of claim 1, wherein:
the one or more trusses further comprise one or more hollow tubes having at least one open end; and
the one or more hollow tubes comprise one or more cable passthroughs coupled to an exterior surface of the one or more open tubes, wherein wiring for the one or more lights passes through the one or more cable passthroughs and into the one or more open tubes.

3. The vehicle photobooth of claim 1, wherein the one or more lifting assemblies are configured to lift the one or more curtains from a bottom portion of the one or more curtains.

4. The vehicle photobooth of claim 1, further comprising a top cap coupled to a top portion of the one or more trusses.

5. The vehicle photobooth of claim 1, further comprising one or more legs coupled to the one or more trusses.

6. The vehicle photographic booth of claim 1, wherein the one or more lifting assemblies are configured to adjust a height of the one or more trusses.

7. The vehicle photographic booth of claim 1, further comprising one or more overhead cameras coupled to a top portion of the vehicle photobooth for tracking a vehicle within the vehicle photobooth.

8. A method of constructing a vehicle photobooth, the method comprising:
slidably coupling one or more curtains to a zip track, wherein one or more trusses comprise the zip track;
coupling one or more lifting assemblies to the one or more trusses; and
coupling one or more lights to the one or more trusses.

9. The method of claim 8, wherein:
the one or more trusses further comprise one or more hollow tubes having at least one open end;
the one or more hollow tubes comprise one or more cable passthroughs coupled to an exterior surface of the one or more open tubes; and
the method further comprises passing wiring for the one or more lights through the one or more cable passthroughs and into the one or more open tubes.

10. The method of claim 8, further comprising lifting the one or more curtains from a bottom portion of the one or more curtains using the one or more lifting assemblies.

11. The method of claim 8, further comprising coupling a top cap to a top portion of the one or more trusses.

12. The method of claim 8, further comprising coupling one or more legs to the one or more trusses.

13. The method of claim 8, further comprising adjusting a height of the one or more trusses using the one or more lifting assemblies.

14. The method of claim 8, further comprising coupling one or more overhead cameras to a top portion of the vehicle photobooth, wherein the one or more overhead cameras are configured to track a vehicle within the vehicle photobooth.

15. A method of using a vehicle photobooth, the method comprising:
moving a vehicle into the vehicle photobooth comprising:
one or more trusses comprising a zip track;
one or more curtains slidably coupled to the zip track;
one or more lifting assemblies coupled to the one or more trusses; and
one or more lights coupled to the one or more trusses; and
capturing photographs of the vehicle using a camera.

16. The method of claim 15, wherein:
the one or more trusses further comprise one or more hollow tubes having at least one open end; and
the one or more hollow tubes comprise one or more cable passthroughs coupled to an exterior surface of the one or more open tubes, wherein wiring for the one or more lights passes through the one or more cable passthroughs and into the one or more open tubes.

17. The method of claim 15, further comprising, before moving the vehicle, lifting the one or more curtains from a bottom portion of the one or more curtains using the one or more lifting assemblies.

18. The method of claim 15, wherein the vehicle photobooth further comprises a top cap coupled to a top portion of the one or more trusses.

19. The method of claim 15, wherein the vehicle photobooth further comprises one or more legs coupled to the one or more trusses.

20. The method of claim 15, further comprising, before moving the vehicle, lifting the one or trusses using the one or more lifting assemblies.
